(19) United States
(12) Patent Application Publication
(10) Pub. No.: US 2014/0098720 A1
(43) Pub. Date: Apr. 10, 2014

(54) Methods, Devices and Computer Program Products for Interference Reduction in TDD Systems Allowing Allocation of Flexible Subframes for Uplink or Downlink Transmission

(71) Applicant: Broadcom Corporation, Irvine, CA (US)

(72) Inventors: Erlin ZENG, Beijing (CN); Chunyan GAO, Beijing (CN); Haiming WANG, Beijing (CN); Jing HAN, Beijing (CN)

(73) Assignee: Broadcom Corporation, Irvine, CA (US)

(21) Appl. No.: 14/077,439

(22) Filed: Nov. 12, 2013

Related U.S. Application Data
(63) Continuation of application No. PCT/CN2011/074058, filed on May 13, 2011.

(51) Int. Cl. H04W 72/04; H04L 5/14

(52) U.S. Cl. CPC H04W 72/0406; H04L 5/14
USPC 370/280

(57) ABSTRACT

Methods, devices and computer program products in relation to interference reduction are presented, in particular for devices comprising a transceiver module configured for TDD operation in a network environment wherein a partition of subframes of channels are configurable to be flexibly assigned for downlink or uplink transmission while other subframes are fixedly configured for either uplink or downlink transmission. Aspects of such devices encompasses a controller module configured to determine those subframes that are flexibly assigned and configured for downlink transmission, identify, among those determined subframes, a subframe carrying a control channel, and restrict physical resources for the control channel in the identified subframe. The invention also addresses corresponding receiving devices and terminals as well as associated methods.

### FIELD OF THE INVENTION

The present invention relates to methods, devices and computer program products for interference reduction in TDD systems allowing allocation of flexible subframes for uplink or downlink transmission. More specifically, the present invention relates to those methods and devices configured for TDD operation in a network environment, wherein a partition of subframes of channels are configurable to be flexibly assigned for downlink or uplink transmission while other subframes are fixedly configured for either uplink or downlink transmission, and to reduce interference on control channels in such environment.

### BACKGROUND

Mobile data transmission and data services are constantly making progress. With the increasing penetration of such services, a need for increased bandwidth for conveying the data is emerging. The more efficiently bandwidth is used, the higher the probability for interference gets. In particular, inference on control data or control channels is crucial as corrupted control data will adversely affect the entire system performance and operation.

Currently, a system known as Long Term Evolution, LTE, is being further developed. The present invention relates to its further development referred to as LTE-Advanced system (LTE-A), which will be part of 3GPP LTE Rel-11. More specifically, it focuses on the configuration of a TDD system in a local area scenario.

Allowing for asymmetric UL-DL allocations has been claimed as one benefit of deploying TDD system. The asymmetric resource allocation in LTE TDD is realized by providing seven different semi-statically configured uplink-downlink configurations. These allocations can provide (in uplink direction) between 40% and 90% of the DL subframes.

For TDD deployments in general, interference between UL and DL including both basestation-to-basestation and UE-to-UE interference needs to be considered. The DL-UL interference in a TDD network is typically handled by statically provisioning a guard period and adopting the same frame timing and uplink-downlink configuration practically in the entire network. However, in local area (LA) network, it may be of interest to consider different UL/DL allocations in the neighboring cells, since same DL/UL configuration may not match the traffic situation in different LA cells with a small number of users.

The main property as we consider for a LA network scenario is that the typical cell size is small comparing with a macro cell, and the number of UEs connected to each eNB (or AP) in the network is not large. And also, LA network deployment maybe does not consider network planning and optimization. DL-UL interference is one obstacle to deploy flexible TDD LA network. Now, consider a TDD deployment scenario with each cell frame synchronized, but not switch point synchronized. In this case, if each cell chooses one TDD configuration from seven TDD configuration patterns defined, there is no DL-UL interference problem for subframe 0, 1, 2 and 5 since these subframes have fixed link direction in any TDD configurations defined.

For other subframes, their link direction can change with TDD configuration, and there can be DL-UL interference depending on the TDD configuration adopted in neighboring cells. Then, in this description, the subframes like 0, 1, 2 and 5 which have fixed link direction are called fixed subframe, while other subframes are called flexible subframe for simplicity. It is to be noted that the fixed subframe and flexible subframe can change depending on the TDD configurations allowed to be adopted, e.g, if a network only supports TDD configurations 1 and 2, then subframes 0, 1, 2, 4, 5, 6, 7, 9 are all fixed subframes, while subframes 3 and 8 are flexible subframes which are set as UL in TDD configuration 1 and DL in TDD configuration 2.

DL-UL interference in flexible subframes will degrade the SINR significantly. For data transmission in a flexible subframe, link adaptation and HARQ can help to adapt to the interference level, but for control signaling to be transmitted in the flexible subframe(s), it is more sensitive to the interference due to lack of HARQ, and it will further reduce the throughput.

One straightforward way to avoid DL-UL interference in control signaling is to limit all the control channels in the fixed subframes, but some disadvantages are identified for such methods:
there is increased DL control overhead in the fixed DL subframes;
by putting all control in fixed subframes, a new HARQ timing needs to be introduced which will increase the implementation complexity;
the interference to/from the data channel in the flexible subframes remains unsolved;
to protect UL control in PUCCH, there is also the proposal of reserving band edge PRBs for PUCCH use, and no PDSCH is allowed in this PRBs via scheduling restrictions. The problem here is that scheduling restriction can only avoid PDSCH transmissions in some PRBs, but PDCCH, PCFICH and CRS shall still be transmitted in edge PRBs to keep backward compatibility. Therefore, interference between PDCCH/PCFICH/CRS and PUCCH still exists.

Thus, there is still a need to further improve such systems in terms of proper interference reduction.

### SUMMARY

The present invention addresses such situation and proposes, in exemplary embodiments, new solutions to efficiently reduce the interference in uplink and downlink on control channels as well as on data channels.

Various aspects of examples of the invention are set out in the claims.

According to a first aspect of the present invention, there is provided
a device, comprising a transceiver module configured for TDD operation in a network environment wherein a partition of subframes of channels are configurable to be flexibly assigned for downlink or uplink transmission while other subframes are fixedly configured for either uplink or downlink transmission, a controller module configured to determine those subframes that are flexibly assigned and configured for downlink transmission, identify, among those determined subframes, a subframe carrying a control channel, and restrict physical resources for the control channel in the identified subframe;
   and there is likewise provided
a method, comprising provisioning a transceiver module configured for TDD operation in a network environment wherein a partition of subframes of channels are configurable to be flexibly assigned for downlink or uplink transmission while other subframes are fixedly configured for either uplink or downlink transmission, configuring a controller module for determining those subframes that are flexibly assigned and configured for downlink transmission, identifying, among those determined subframes, a subframe carrying a control channel, and restricting physical resources for the control channel in the identified subframe.

Advantageous further developments are as set out in respective dependent claims thereof.

According to a second aspect of the present invention, there is provided
a device, comprising a transceiver module configured for TDD operation in a network environment wherein a partition of subframes of channels are configurable to be flexibly assigned for downlink or uplink transmission while other subframes are fixedly configured for either uplink or downlink transmission, the transceiver comprising a receiver configured to receive, via a first physical channel, information indicative of at least restricted physical resources and optionally of a modified format applied on a downlink control channel, and a controller module, configured to control the receiver so as to monitor the downlink control channel conveyed in a flexible subframe on the basis of the information received;
   and there is likewise provided
a method, comprising provisioning a transceiver module configured for TDD operation in a network environment wherein a partition of subframes of channels are configurable to be flexibly assigned for downlink or uplink transmission while other subframes are fixedly configured for either uplink or downlink transmission, configuring a receiver of the transceiver for receiving, via a first physical channel, information indicative of at least restricted physical resources and optionally of a modified format applied on a downlink control channel, and configuring a controller module for controlling the receiver so as to monitor the downlink control channel conveyed in a flexible subframe on the basis of the information received.

According to a third aspect of the present invention, there is provided
a device, comprising a transceiver module configured for TDD operation in a network environment wherein a partition of subframes of channels are configurable to be flexibly assigned for downlink or uplink transmission while other subframes are fixedly configured for either uplink or downlink transmission, a controller module configured to determine those subframes that are flexibly assigned and configured for downlink transmission, identify, among those determined subframes, a subframe carrying a control channel, control a transmitter of the transceiver module to transmit information indicative of restricted physical resources for the control channel in the identified subframe;
   and there is likewise provided
a method, comprising:
provisioning a transceiver module configured for TDD operation in a network environment wherein a partition of subframes of channels are configurable to be flexibly assigned for downlink or uplink transmission while other subframes are fixedly configured for either uplink or downlink transmission, configuring a controller module for determining those subframes that are flexibly assigned and configured for downlink transmission, identifying, among those determined subframes, a subframe carrying a control channel, controlling a transmitter of the transceiver module to transmit information indicative of restricted physical resources for the control channel in the identified subframe.

Advantageous further developments are as set out in respective dependent claims thereof.

According to a fourth aspect of the present invention, there is provided
a device, comprising a transceiver module configured for TDD operation in a network environment wherein a partition of subframes of channels are configurable to be flexibly assigned for downlink or uplink transmission while other subframes are fixedly configured for either uplink or downlink transmission, a controller module configured to determine those subframes that are flexibly assigned and configured for downlink transmission of a control channel at another device, control a receiver of the transceiver module to receive information indicative of restricted physical resources for the control channel in the identified subframe;
   and there is likewise provided
a method, comprising provisioning a transceiver module configured for TDD operation in a network environment wherein a partition of subframes of channels are configurable to be flexibly assigned for downlink or uplink transmission while other subframes are fixedly configured for either uplink or downlink transmission, configuring a controller module for determining those subframes that are flexibly assigned and configured for downlink transmission of a control channel at another device, controlling a receiver of the transceiver module to receive information indicative of restricted physical resources for the control channel in the identified subframe.

Advantageous further developments are as set out in respective dependent claims thereof.

According to a fifth aspect of the present invention, there are provided computer program products comprising computer-executable components which, when executed on a computer, are configured to implement the respective methods according to the aspects as set our herein above. The above computer program product/products may be embodied as a computer-readable storage medium.

Thus, improvement is achieved by those methods, devices and computer program products, in that at feast in connection with exemplary embodiments: The benefit of at least exemplary embodiment 1 is that an eNB can adjust the control region based on needs;

by restricting the PDCCH in a subband, it enables interference reduction to/from PDCCH/PUCCH without need of shorten PUSCH format;

With at least exemplary embodiment 1 and 2, the interference can be reduced based on dynamic scheduling information (which is exchanged via fast inter-eNB coordination newly introduced and differing from the usually used backhaul connection), which is more efficient when compared with the backhaul coordination-based scheme; the delay in such fast inter-eNB coordination is only around 10 ms, during which the scheduling decision is not expected to change dramatically in the scenario of interest.

With all exemplary embodiments, the control channel is allowed in the flexible subframes, which avoid control channel overload in the fixed subframes.

Thus, with the present invention implemented, solutions to handle the DL-UL interference problem introduced by cell-specific TDD configuration in LA network scenario is improved.

### BRIEF DESCRIPTION OF DRAWINGS

For a more complete understanding of example embodiments of the present invention, reference is now made to the following descriptions taken in connection with the accompanying drawings in which:

FIG. 1 schematically illustrates an exemplary example of inter-eNB communication on layer 1;

FIG. 2A schematically illustrates parts of a typical SC-FDMA receiver at an eNB;

FIG. 2B schematically illustrates an exemplary example of a receiver at an eNB modified for inter-eNB signaling according to one option according to an aspect of the invention;

FIG. 3A schematically illustrates parts of a typical OFDM transmitter at an eNB;

FIG. 3B schematically illustrates an exemplary example of a transmitter at an eNB modified for inter-eNB signaling according to another option according to an aspect of the invention.

### DESCRIPTION OF EXEMPLARY EMBODIMENTS

Exemplary aspects of the invention will be described herein below.

It is to be noted that the following exemplary description refers to an environment of the LTE system (Long Term Evolution) and/or local area (LA) networks thereof. However, it is to be understood that this serves for explanatory purposes only. Other systems differing from the LTE system can be adopted as long as they deploy similar configurations and enable asymmetric resource allocation for uplink and downlink transmission to/from an access point such as an evolved Node_B, eNB. Generally, aspects of the present invention can be deployed in relation to any TDD system (time division duplex) allowing for flexible allocation of transmission frames in terms of the link direction, i.e. uplink UL or downlink DL.

A respective eNB as an access point in the broadest sense communicates with one or more terminal devices, referred to also as user equipment UE, using control channels as well as payload channels. A user equipment can be a mobile phone, a smart phone or personal computer connectable to a network such as LTE network or other (WCDMA, WIMAX, WLAN or the like) as long as they deploy TDD.

Also, respective eNBs and/or access points receive and transmit information from network entities and/or from/to other eNBs. It is to be noted that while at least some aspects in relation to the present invention are described with reference to a device adapted to transmit or to receive certain information, it is, however, to be understood that in practice such devices typically combine both functions, i.e. unite a transmitting and receiving capability. Insofar, of course, individually described aspects and/or features of the present invention can generally be combined.

In the following specification, the following definitions are applied for description purposes:

“eNB #1” denotes a first type of an eNB; such first type eNB#1 is an eNB which will transmit DL physical channel such as PCFICH, PDCCH, and PDSCH in a flexible subframe #m in a radio frame #n. A radio frame comprises 10 subframes 0 to 9, so #m is within the range of 0 to 9.

“eNB #2” to “eNB #N” denote a second type of eNB; such second type eNB is one or more eNBs which assume an UL subframe in their own cells in the flexible subframe #m. Thus, those second type eNBs will transmit in UL while the first type eNBs will transmit in downlink in the same subframe.

According to both exemplary embodiments, embodiment #1 and #2, fast inter-eNB coordination (via L1 signalling) is introduced, carrying the scheduling information related to one or more eNB's of type #1. In both exemplary embodiments, it is proposed to limit the bandwidth of the DL control transmission in the cell of one or more eNBs of the first type, eNB #1, within a certain bandwidth. Based on at least exemplary embodiment #1, the interference on data and control channel in all the cells can be reduced with a correspondingly adapted eNB scheduler implementation.

### Exemplary Embodiment #1

Basically, according to this exemplary embodiment, the PDCCH from (one or more) eNBs of first type is restricted to certain PRB set S and certain number of OFDMA symbols L in a flexible subframe #m in which the eNB#1 (or the eNBs of type 1, respectively) transmit in DL. In case there is only one eNB of first type, the set S and L is indicated to the UEs in the cell of that eNB #1 via physical control channel PCFICH. The PCFICH in the cell of eNB #1 is transmitted in some predefined physical resources P, independent of the (restricted) size of the control region, i.e. the PDCCH. The terminals UEs in the cell of eNB #1 (or those in the respective cells of plural eNBs of first type) only monitor the (respective) PDCCH with the set of (the respective) resources defined by S and L in a flexible subframe for the respective eNB of type 1.

In case of plural eNBs of first type, the information sent by the multiple eNBs of first type like eNB #1 do not have to be the same, e.g., the set S and L and/or some other scheduling information mentioned herein below do not have to the same among the multiple eNBs.

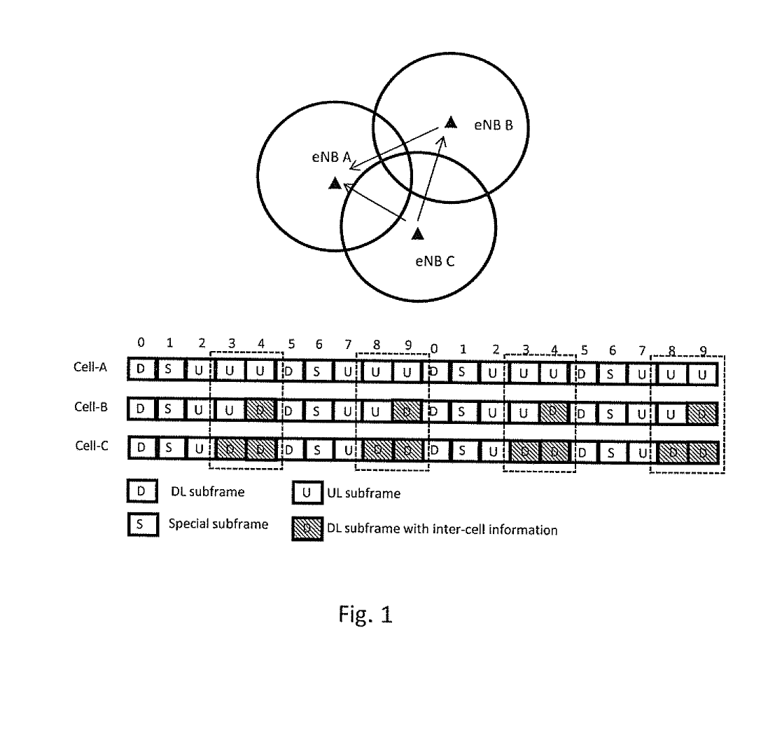

The control region (e.g., the respective set S and L) can be updated by the corresponding eNB to which it pertains. So, in order for the UEs within the cell of the respective eNB to know about this update, PCFICH has to be transmitted in some pre-defined resources. So here the resource P stands for the predefined resources, and the control region means the set of resources (S and L) that are used for DL control (e.g. PDCCH) transmissions. The exact resources used for such PCFICH can be predefined, and there is actually no restriction on where to put such resources. The only requirement in this regard is that the resources used for the PCFICH in this case shall not be a function of the size of PDCCH. Hence, such resource may be one or more subframes in downlink direction that is not a flexible subframe. For example, it may be contained in subframe 0 and/or 1 of each radio frame which are transmitted before the flexible subframe (subframes 3 and 4 in the example illustrated in FIG. 1). This represents thus one feasible way to make the UEs attached to a respective eNB #1 (i.e. of first type) aware of the control region on a flexible subframe, and generally such PCFICH signal and/or PCFICH-like signal in the cell of a respective eNB #1 can be transmitted in any DL subframe(s) before the flexible subframe(s) to which the restricted control region applies.

The eNB #2-#N, i.e. the eNBs of the second type, are informed about the PRB set S beforehand, via certain physical channels C between the (one or more) eNB #1 of the first type and the other eNBs #2-#N of the second type.

In case of plural eNBs of type 1, each such eNB #1 would use one channel C for such communication to the eNBs of type 2. When there would be multiple eNBs of type #1, it is possible that these different channel Cs would be multiplexed in some way. The parameters to be able to do such multiplexing can be exchanged via a backhaul link (distinct from channel C) between the different eNBs. For example, information from the multiple eNBs can be multiplexed in several possible ways, e.g., TDM, CDM, or FDM. For such multiplexing, the necessary parameters (e.g., those parameters mentioned herein below in relation to exemplary embodiment #2) can be exchanged via the backhaul link between the eNBs concerned.

In order to avoid interference to/from the DL control from eNB #1, the set S and L can be informed “beforehand” to the other eNB #2-#N, i.e. that information is shared before all the eNBs schedule the DL or UL transmissions in the flexible subframes. With regard to the example scenario shown in FIG. 1, the set or sets S and L are e.g. transmitted upon a first occurrence of those flexible subframes (3 and 4 in FIG. 1) and that only in following flexible subframes, the transmissions take that information into account (e.g. subframes 8 and 9 in FIG. 1). Note that in FIG. 1, in the subframes, horizontal axis denotes time and vertical axes the PRBs e.g. in frequency/bandwidth domain.

Those eNB #2-#N of the second type take the PEW set (or sets) S into account in PUSCH scheduling in UL subframe #m in their own cells. This means that is that eNBs of second type (eNB#2) will avoid to schedule any UL transmissions in the informed resource sets. An exact scheduling algorithm would be up to eNB's implementation, while the proposed schemes just allow for certain possibilities of addressing and reducing the interference in the flexible subframes. Assuming a scenario in which two eNB's of type #1 send PRB sets S1 and S2 out to a single eNB of type#2, with set S1 being complementary to set S2 and S1+52 is all that is available of PRBs. In such scenario, when there are two eNBs of type #1 which would send S1 and S2 to a single eNB of type #2, respectively, one possible implementation of eNB type #2 would be to avoid UL scheduling in the resources corresponding to set S1+S2. The exact scheduling algorithm would be implementation specific. If no more PRBs apart from S1 and S2 were available, the eNB could be configured to decide to use PRBs within one of those sets based on appropriate additional information such as measurement report, or select preconfigured resources in such case (e.g. those in the lower bandwidth).

To avoid/reduce DL-UL interference on data channels, more specifically, the interference from PDSCH transmitted by eNB #1 to the PUSCH/PUCCH in the other cells of eNB #2-#N or vice versa, the following is exemplarily proposed.

### Exemplary Embodiment 2

A physical channel denoted as “channel C” is introduced between eNB #1 of first type and all the other eNBs #2-#N of the second type in a flexible subframe #m. The physical channel C may be based on PDSCH or PUSCH/PUCCH format, which are specified in LTE Rel-8/9/10. The information conveyed by physical channel C at least includes the scheduling information in a time period that is next to the flexible subframe #m.

In practice the information on channel C may not have to be sent four times per radio frame as suggested in the exemplary FIG. 1 (illustrated to be sent in subframes 3, 4, 8, and 9). In this scenario as shown, it will be taken into account for UL scheduling in subframes not illustrated in FIG. 1, If it is shared less frequent, say once per 10 ms or 20 ms (i.e once per radio frame or once per 2 radioframes), then it can be taken into account by eNB #2 before doing UL scheduling in the flexible subframes (e.g. only in the first instance of flexible subframes 3 and 4; then it can be taken into account in the following flexible subframes 8, 9 and the second instance (subsequent radio frame) of the flexible subframes 3, 4, 8, and 9, shown in FIG. 1). Note that 10 subframes (denoted with indexes 0 to 9) of 1 ms duration each constitute a respective radioframe of 10 ms. Note further, for the sake of completeness, that subframes denoted with S as “special subframes” represent respective TDD-specific subframes containing three parts, i.e DwPTS (Downlink Pilot TimeSlot), GP (Guard Period), and UpPTS (Uplink Pilot TimeSlot).

Examples of such scheduling information are which subband will be scheduled and the transmit (Tx) power and precoding matrix indicator PMI for that scheduling; The parameters that are necessary for transmission/reception of the physical channel C are informed or exchanged via certain backhaul link between the eNBs. The parameters above may include, e.g., frequency/time resources, modulation and coding scheme, cell IDs used for deriving the scrambling code or cyclic shift for channel C, the system frame number of the transmitting or receiving cells, where appropriate. The other eNBs #2-#N of second type take the scheduling information that is obtained from the physical channel C into account when accomplishing PUSCH/PUCCH scheduling in their own cells.

In relation to both exemplary embodiments 1 as well as 2, a semi-static TDD configuration in each cell is assumed, and the configuration is exchanged via backhaul signaling between eNBs, e.g, using the interface known as “X2”. To enable dynamic interference avoidance/reduction, a channel C for L1 inter-eNB signaling is introduced (in addition to the backhaul interface such as X2).

IN connection with data transmission via that interface C, firstly the cells are divided into 2 groups. The groups are distinguished in terms of cells which configure the flexible subframe as DL to be in group A (i.e. group A comprises eNBs of the first type #1 as defined above), while the cells which configure the flexible subframe as UL to be in group B (i.e. group B comprises eNBs of the second type #2 as defined above). The group members may vary for each flexible subframe. The L1 inter-eNB signaling is sent from group A eNBs to group B eNBs. In each cell, there are reserved resources for the inter-eNB L1 signaling via interface C where other control/data transmission are avoided. These reserved resources are coordinated between eNBs via backhaul signaling, e,g, X2, semi-statically. FIG. 1 shows one example for cell-specific TDD configuration and the L1 inter-eNB communication.

In the upper portion of FIG. 1, three eNBs A, B, and C are illustrated together with the signaling between them. In the lower portion of FIG. 1, exemplarily 2 radioframes are illustrated together with exemplary inter-eNB signaling. Note that as illustrated, L1 signaling via interface C occurs 4 times in 2 radioframes, but this is not required, as mentioned above.

As shown in FIG. 1, in the flexible subframes 3 and 4, cells are grouped,

For flexible subframe 3, eNBs A and B constituting cells A and B are configured to transmit in UL, while eNB C constituting cell C is configured to transmit in DL. Thus, eNBs A and B are of the second type and thus form group B of eNBs, while eNB C is of first type and constitutes group A of eNBs. Then, interface C is used to transmit from eNB C towards eNBs A and B, respectively.

For flexible subframe 4, however, the situation is different. Namely, eNB A constituting cell A is configured to transmit in UL, while eNBs B and C constituting cells B and C, respectively, are both configured to transmit in DL. Thus, eNB A is of the second type and thus forms group B of eNBs, while eNBs B and C are of first type and constitute group A of eNBs. Then, interface C is used to transmit from eNBs B and C, respectively, towards eNB A,

There are two options for the L1 signaling transmission.

Option #1

Group A eNBs transmit PDSCH in the DL in its own cell.

Assuming group A eNB is transmitting in its own cell with the following settings (semi-statically determined)
n physical resource blocks PRB are used from block x to block x+n
   (#x-#x+n), where n is the number of PRBs assigned for the transmission
modulation and coding scheme MCS #k
   (k denoting a kth scheme out of plural ones available)
PDSCH transmission format is used

In such option, there is no impact on the transmission (Tx) chain of group A eNB. Nevertheless, some extra implementation and/or modification is necessary at the receiver of group B eNBs in the respective neighboring cell.

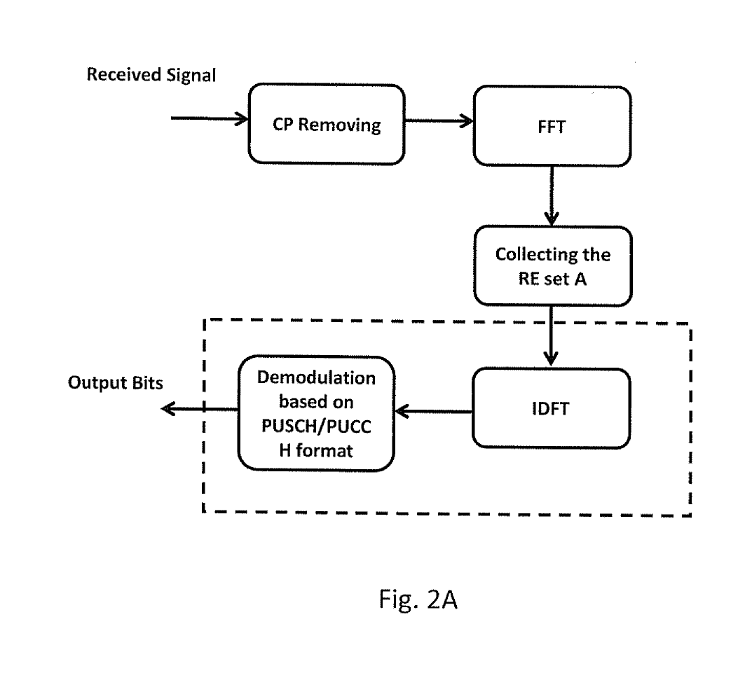

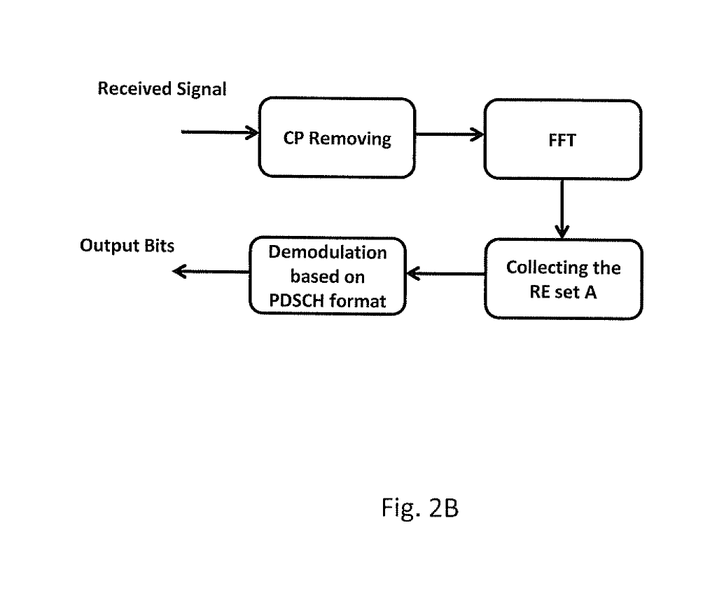

FIG. 2A shows a typical SC-FDMA receiver, while FIG. 2B shows how group B eNBs detect and/or process the PDSCH received from group A eNBs according to this option of the exemplary embodiment. In the Figure, RE set A denotes the resource elements set that are corresponding to the resources used for L1 inter-eNB signaling in PDSCH format in PRB #x-#x+n. The different implementation from a SC-FDMA receiver is mainly within the dashed block, i.e., after collecting the REs from set A, there is no need for an inverse discrete Fourier transform, IDFT, operation but just the channel estimation and demodulation based on the configured PDSCH format is carried out in the frequency domain. This means that in the baseband algorithm, group B eNBs need to support the channel estimation based on the reference signal configured for the PDSCH, and there is a need for Turbo decoding at group B eNBs.

Option #2

Group A eNBs transmit virtual PUSCH/PUCCH in the DL in its own cell, respectively. Assuming group A eNBs are transmitting in their respective own cell with the following settings (semi-statically determined)
PRB #x-#x+n,
   where n is the number of PRBs assigned for the transmission
MCS #k
PUSCH/PUCCH transmission format is used

There is no impact on the receiver (Rx) chain of group B eNBs in the neighboring cell. Nevertheless, some extra implementation and/or modification is necessary at the transmitter side of group A eNBs.

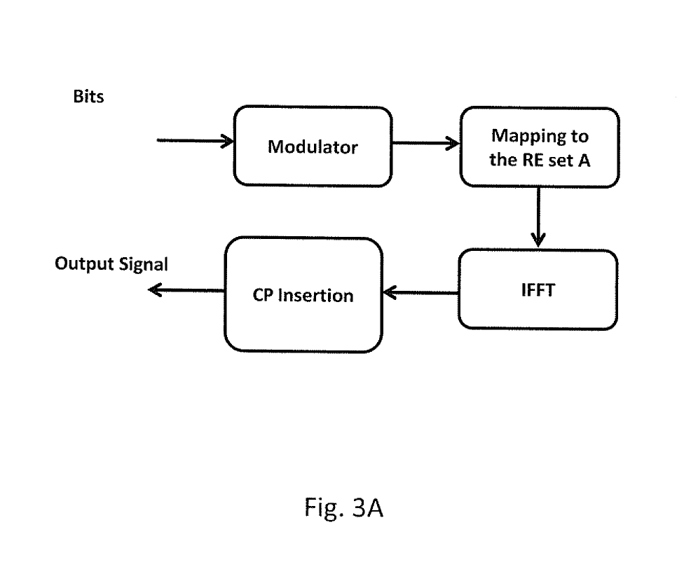

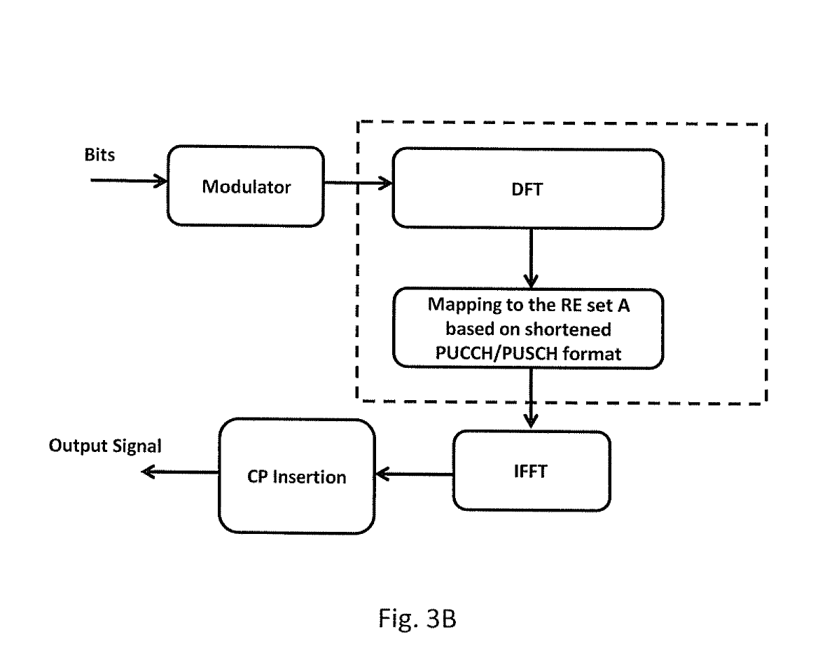

FIG. 3A shows a typical OFDMA transmitter, while FIG. 3B shows how L1 inter-eNB signaling is transmitted from group A eNBs using PUCCH/PUSCH format in the DL subframe. In the Figure, RE set A denotes the resource elements set that are corresponding to the resources used for PUCCH/PUSCH format transmission from group A eNBs in PRB #x-#x+n. The different implementation from a typical OFDMA transmitter is mainly within the dashed block, i.e., the modulated symbols in FIG. 3B need to go through a discrete Fourier Transformation, DFT, first to transfer to the frequency domain, and then the frequency domain data is mapped to the RE set A according to the PUSCH/PUCCH format. The reference signal mapping, although not shown in the figure, shall also follow the PUSCH/PUCCH reference signal (RS) format, which is different from the PDSCH RS transmission. The encoding for PUCCH/PUSCH shall follow the Reed-Muller code (RM) for UL control channel encoding for PUCCH or tail-biting convolutional encoding (TBCC coding), but this is not considered as extra complexity since TBCC is already supported in the LTE Rel-8/9/10 PDCCH transmissions.

By comparing these two options, it can be observed that the extra complexity would be on respective different sides of the link with these options, i.e. either on receiving or transmitting side. With option #1 there is no need for specifying a new shortened PUSCH/PUCCH format in the DL, but that the complexity is mainly on the receiver side which is up to be implemented.

In case of multiple eNBs in group A, there are multiple eNBs sending L1 inter-eNB signaling. They can be multiplexed in FDM or CDM way depending on the transmission format. And the multiplexing parameters are also coordinated semi-statically, e.g, via X2 backhaul interface. In case some eNB in group B can not detect the signaling correctly, it can trigger higher-layer coordination, via X2 interface, to change transmission parameters for L1 inter-eNB signaling. According to an exemplary embodiment, in the inter-eNB L1 signaling, the eNBs of group A cells which configure the flexible subframe to be DL inform in advance to neighbor cells which subband will be occupied in flexible subframes in next period, e.g, next radio frame, and what PMI will be used for the scheduled UEs in those subbands. This helps the group B cells which configure the flexible subframe to be UL to optimize the UL scheduling and thus to avoid/reduce DL-UL interference.

For example, if group B eNB found that a certain subband i, j will be occupied in a flexible subframe of a next radio frame, then it can schedule UL in subbands other than i and j. For another example, if group B eNB found that most subband are occupied but based on the information of PMI and inter-eNB channel estimation H, it can further detect the interference level for each subband. If only subband x,y will cause strong interference, it can schedule some center UEs in subbands other than x and y. (Note that subband i and/or j are not illustrated in the Figure; in practice these subbands can be placed anywhere in the frequency domain; they can be corresponding to any frequency subbands that would be used by eNB of type #1 for DL transmissions, e.g. in flexible subframe #4 (or #3 and #4) and subframe #9 (or #8 and #9); In practice, the only restriction on the placement of these subbands would be the granularity of signaling for indicating these subbands, for example when we have a full-bit map for indicating the subbands, they can be placed anywhere in the frequency domain.)

The advantage of the exemplary embodiment 2 is mainly that it enables dynamic interference avoidance/reduction, which helps to improve the spectrum efficiency; Furthermore, UE implementation is not impacted, and the requirement to eNB is not strict. It only requires the group B eNBs to perform a DL reception.

Generally, and as has been described herein above, the invention is implemented in an environment such as LTE system adopting a local area scenario. Exemplary embodiments of the invention are represented by methods and/or correspondingly configured devices such as eNBs and/or UEs. More specifically, the invention generally relates to modules of such devices. Other systems can benefit also from the principles presented herein as long as they have identical or similar properties like the TDD under LTE allowing for asymmetric UL-DL resource allocation.

Embodiments of the present invention may be implemented in software, hardware, application logic or a combination of software, hardware and application logic. The software, application logic and/or hardware generally, but not exclusively, may reside on the devices' modem module. In an example embodiment, the application logic, software or an instruction set is maintained on any one of various conventional computer-readable media. In the context of this document, a “computer-readable medium” may be any media or means that can contain, store, communicate, propagate or transport the instructions for use by or in connection with an instruction execution system, apparatus, or device, such as a computer or smart phone, or user equipment.

The present invention relates in particular but without limitation to mobile communications, for example to environments under LTE, WCDMA, WIMAX and WLAN and can advantageously be implemented in user equipments or smart phones, or personal computers connectable to such networks. That is, it can be implemented as/in chipsets to connected devices, and/or modems or other modules thereof.

If desired, at least some of different functions discussed herein may be performed in a different order and/or concurrently with each other. Furthermore, if desired, one or more of the above-described functions may be optional or may be combined.

Although various aspects of the invention are set out in the independent claims, other aspects of the invention comprise other combinations of features from the described embodiments and/or the dependent claims with the features of the independent claims, and not solely the combinations explicitly set out in the claims.

It is also noted herein that while the above describes example embodiments of the invention, these descriptions should not be viewed in a limiting sense. Rather, there are several variations and modifications which may be made without departing from the scope of the present invention as defined in the appended claims.

The present invention proposes methods, devices and computer program products in relation to interference reduction, in particular for devices comprising a transceiver module configured for TDD operation in a network environment wherein a partition of subframes of channels are configurable to be flexibly assigned for downlink or uplink transmission while other subframes are fixedly configured for either uplink or downlink transmission. Aspects of such devices encompass a controller module configured to determine those subframes that are flexibly assigned and configured for downlink transmission, identify, among those determined subframes, a subframe carrying a control channel, and restrict physical resources for the control channel in the identified subframe. In another aspect, such devices encompass control of a transmitter of the transceiver module to transmit information indicative of restricted physical resources for the control channel in the identified subframe. The invention also addresses corresponding receiving devices and terminals as well as associated methods.

### LIST OF ACRONYMS AND ABBREVIATIONS USED

LA Local Area

CRC Cyclic Redundancy Check

CCE Control channel element

DL Downlink

eNB Enhanced Node B. Name for Node B in LTE

HARQ Hybrid automatic repeat request

LTE Long Term Evolution

LTE-A Long Term Evolution Advanced

PDCCH Physical Downlink Control Channel

PUSCH Physical Uplink Shared Channel

PCFICH Physical Control Format Indicator Channel

PHICH Physical Hybrid ARQ Indicator Channel

RRC Radio Resource Control

TDD Time Division Duplex

UE User Equipment

UL Uplink

RS Reference Signal

PMI Precoding Matrix Indicator

X2 inter-eNB I/F as defined in 3GPP

MCS Modulation and Coding scheme

SC Single Carrier

CP Cyclic Prefix

RM Reed Muller, code used in LTE, e.g., for UL control channel encoding for PUCCH

TBCC Tail-Biting Convolutional Coding

IFFT Inverse Fast Fourier Transform

DFT Discrete Fourier Transform

DwPTS Downlink Pilot TimeSlot

GP Guard Period

UpPTS Uplink Pilot TimeSlot

1. A device, comprising:
a transceiver module configured for time division duplex (TDD) operation in a network environment wherein a partition of subframes of channels are configurable to be flexibly assigned for downlink or uplink transmission while other subframes are fixedly configured for either uplink or downlink transmission, and
a controller module configured to
determine those subframes that are flexibly assigned and configured for downlink transmission,
identify, among those determined subframes, a subframe carrying a control channel, and
restrict physical resources for the control channel in the identified subframe.

2. A device according to claim 1, wherein said controller module is further configured to modify the format of data transmission in said identified subframe within the restricted physical resources.

3. A device according to claim 1, wherein the transceiver module further comprises a transmitter configured to transmit information indicative of at least the restricted physical resources and optionally of the modified format.

4. A device according to claim 3, wherein said transmitter is configured to:
transmit said information via a first physical channel to terminals, and
transmit said information via a second physical channel to other devices.

5. A device according to claim 4, wherein
said first physical channel is a physical control format indicator channel, which is carried in physical resources which are predefined and independent of the information transmitted.

6. A device according to claim 4, wherein
said second physical channel is carried in a subframe that is flexibly assigned and configured for downlink transmission.

7. A device according to claim 1, wherein the transceiver module further comprises a receiver configured to receive information indicative of at least the restricted physical resources and optionally of the modified format via said second physical channel.

8. A device according to claim 7, wherein the controller module is configured to
determine those subframes that are flexibly assigned and configured for uplink transmission, and
control uplink transmission scheduling from terminal devices towards the device on the basis of said received information which is indicative of at least the restricted physical resources and optionally of the modified format applied by another device in the corresponding subframe for downlink transmission of a control channel.

9. A device, comprising:
a transceiver module configured for time division duplex (TDD) operation in a network environment wherein a partition of subframes of channels are configurable to be flexibly assigned for downlink or uplink transmission while other subframes are fixedly configured for either uplink or downlink transmission, the transceiver module comprising a receiver configured to receive, via a first physical channel, information indicative of at least restricted physical resources and optionally of a modified format applied on a downlink control channel, and
a controller module, configured to control the receiver so as to monitor the downlink control channel conveyed in a flexible subframe on the basis of the information received.

10. A device, comprising:
a transceiver module configured for time division duplex (TDD) operation in a network environment wherein a partition of subframes of channels are configurable to be flexibly assigned for downlink or uplink transmission while other subframes are fixedly configured for either uplink or downlink transmission, and
a controller module configured to
determine those subframes that are flexibly assigned and configured for downlink transmission,
identify, among those determined subframes, a subframe carrying a control channel, and
control a transmitter of the transceiver module to transmit information indicative of restricted physical resources for the control channel in the identified subframe.

11. A device according to claim 10, wherein said controller module is configured to format the information transmitted in the identified subframe based on a format of a physical downlink shared channel.

12. A device according to claim 10, wherein said controller module is configured to format the information transmitted in the identified subframe based on a format of a physical uplink shared channel and/or physical uplink control channel.

13. A device according to claim 10, wherein said information indicative of restricted physical resources comprise at least scheduling information for a time period following the identified subframe in terms of which set of restricted subbands will be scheduled, a transmission power to be used and a precoding matrix indicator applied.

14. A device according to claim 10, further comprising a receiver of the transceiver module, configured to receive parameters applied for transmission or reception of information in the identified subframe via a backhaul interface between devices.

15. A device according to claim 14, wherein said parameters include at least one of frequency and time resources, modulation and coding scheme, cell identifiers (IDs) of the devices used for deriving the scrambling code or cyclic shift of the channel conveyed in the identified flexible subframe, system frame number of transmitting/receiving cells.

16. A device, comprising:
a transceiver module configured for time division duplex (TDD) operation in a network environment wherein a partition of subframes of channels are configurable to be flexibly assigned for downlink or uplink transmission while other subframes are fixedly configured for either uplink or downlink transmission, and
a controller module configured to
determine those subframes that are flexibly assigned and configured for downlink transmission of a control channel at another device, and
control a receiver of the transceiver module to receive information indicative of restricted physical resources for the control channel in the identified subframe.

17. A device according to claim 16, wherein said receiver of the transceiver module is configured to receive parameters applied for reception or transmission of information in the identified subframe via a backhaul interface between devices.

18. A device according to claim 16, wherein said parameters include at least one of frequency and time resources, modulation and coding scheme, cell identifiers (IDs) of the devices used for deriving the scrambling code or cyclic shift of the channel conveyed in the identified flexible subframe, system frame number of transmitting/receiving cells.

19-40. (canceled)
